(19) United States
(12) Patent Application Publication
(10) Pub. No.: US 2024/0199074 A1
(43) Pub. Date: Jun. 20, 2024

(54) EGO TRAJECTORY PLANNING WITH RULE HIERARCHIES FOR AUTONOMOUS VEHICLES

(71) Applicant: NVIDIA Corporation, Santa Clara, CA (US)

(72) Inventors: Sushant Veer, Santa Clara, CA (US); Karen Leung, Santa Clara, CA (US); Ryan Cosner, Altadena, CA (US); Yuxiao Chen, Santa Clara, CA (US); Marco Pavone, Santa Clara, CA (US)

(21) Appl. No.: 18/335,028

(22) Filed: Jun. 14, 2023

Related U.S. Application Data
(60) Provisional application No. 63/428,168, filed on Nov. 28, 2022.

(51) Int. Cl. B60W 60/00; B60W 40/02

(52) U.S. Cl. CPC B60W 60/0011; B60W 40/02

(57) ABSTRACT

Autonomous vehicles (AVs) may need to contend with conflicting traveling rules and the AV controller would need to select the least objectionable control action. A rank-preserving reward function can be applied to trajectories derived from a rule hierarchy. The reward function can be correlated to a robustness vector derived for each trajectory. Thereby the highest ranked rules would result in the highest reward, and the lower ranked rules would result in lower reward. In some aspects, one or more optimizers, such as a stochastic optimizer can be utilized to improve the results of the reward calculation. In some aspects, a sigmoid function can be applied to the calculation to smooth out the step function used to calculate the robustness vector. The preferred trajectory selected using the results from the reward function can be communicated to an AV controller for implementation as a control action.

### CROSS-REFERENCE TO RELATED APPLICATION

This application claims the benefit of U.S. Provisional Application Serial No. 63/428,168, filed by Sushant Veer, et al. on Nov. 28, 2022, entitled “EGO TRAJECTORY PLANNING WITH RULE HIERARCHIES FOR AUTONOMOUS VEHICLES,” commonly assigned with this application and incorporated herein by reference in its entirety.

### TECHNICAL FIELD

This application is directed, in general, to directing an autonomous vehicle and, more specifically, to ranking possible trajectories for the autonomous vehicle.

### BACKGROUND

Autonomous vehicles (AVs) may need to contend with conflicting planning requirements, for example, safety and comfort can be at odds with each other if avoiding a collision calls for slamming on the brakes. To resolve such conflicts, assigning importance ranking to rules (such as imposing a rule hierarchy) have been proposed. In turn, this may induce rankings on trajectories derived from the importance of the rules that they satisfy. Rule hierarchies can introduce significant combinatorial complexity to planning. In the worst case, planning with an N-level rule hierarchy may result in solving 2^{N} optimization problems. Prior work uses either a rule hierarchy or a flat reward structure.

### SUMMARY

In one aspect, a method is disclosed. In one embodiment, the method includes (1) collecting a set of world scene parameters from an ego autonomous vehicle (AV), (2) selecting a rule hierarchy from a set of traveling rules for the ego AV. (3) calculating a robustness vector for one or more rules in the rule hierarchy utilizing a trajectory derived from the respective one or more rules, wherein the trajectory is derived using the set of world scene parameters, (4) assigning a reward parameter to the one or more rules in proportion to the respective robustness vector calculated for the one or more rules, (5) generating a set of reward parameters from the one or more rules and the associated reward parameters, and (6) selecting a preferred trajectory derived from the rule hierarchy using the set of reward parameters, wherein the preferred trajectory evaluates to a highest reward.

In a second aspect, a system is disclosed. In one embodiment, the system includes (1) a receiver, operational to receive a set of world scene parameters, a set of hyperparameters, a set of ego AV states for an ego AV, and a set of traveling rules for the ego AV, wherein the ego AV is intending to move, and (2) one or more processors, operational to calculate a robustness vector for cach trajectory derived from a rule in a rule hierarchy and select a preferred trajectory using a reward parameter derived from the robustness vector, where the rule hierarchy is selected from the set of traveling rules and a calculation for the robustness vector utilizes the set of world scene parameters, the set of hyperparameters, and the set of ego AV states.

In a third aspect, a computer program product having a series of operating instructions stored on a non-transitory computer-readable medium that directs a data processing apparatus when executed thereby to perform operations to determine a preferred trajectory for an ego AV is disclosed. In one embodiment, the operations include (1) collecting a set of world scene parameters from the ego AV. (2) selecting a rule hierarchy from a set of traveling rules for the ego AV. (3) calculating a robustness vector for one or more rules in the rule hierarchy utilizing a trajectory derived from the respective one or more rules, wherein the trajectory is derived using the set of world scene parameters, (4) assigning a reward parameter to the one or more rules in proportion to the respective robustness vector calculated for the one or more rules, (5) generating a set of reward parameters from the one or more rules and the associated reward parameters, and (6) selecting the preferred trajectory derived from the rule hierarchy using the set of reward parameters, wherein the preferred trajectory evaluates to a highest reward.

In a fourth aspect, a computing system is disclosed. In one embodiment, the computing system includes (1) a receiver, operational to receive a set of world scene parameters, a set of hyperparameters, a set of states for a robotic device, and a set of traveling rules for the robotic device, wherein the robotic device is intending to move, and (2) one or more processors, operational to calculate a robustness vector for one or more trajectories derived from one or more rules in a rule hierarchy and select a preferred trajectory from the one or more trajectories using a reward parameter derived from the robustness vector, where the rule hierarchy is selected from the set of traveling rules and a calculation of the robustness vector utilizes the set of world scene parameters, the set of hyperparameters, and the set of states.

### BRIEF DESCRIPTION

Reference is now made to the following descriptions taken in conjunction with the accompanying drawings, in which:

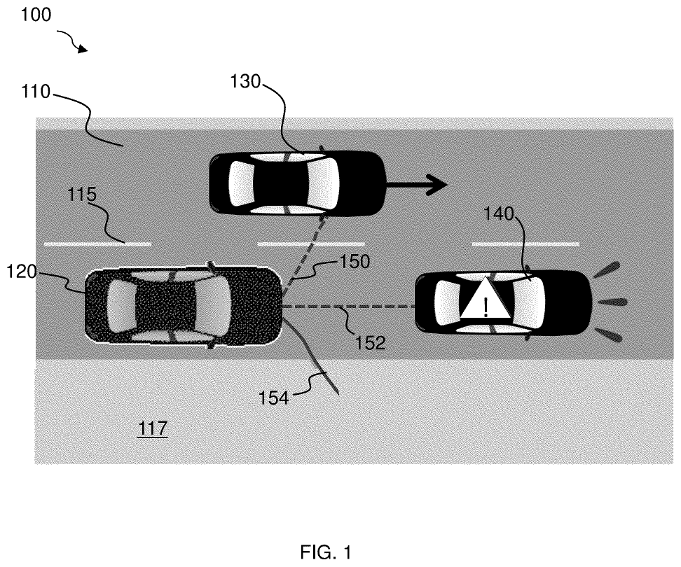

FIG. 1 is an illustration of a diagram of an example trajectory decision moment for an ego autonomous vehicle (AV);

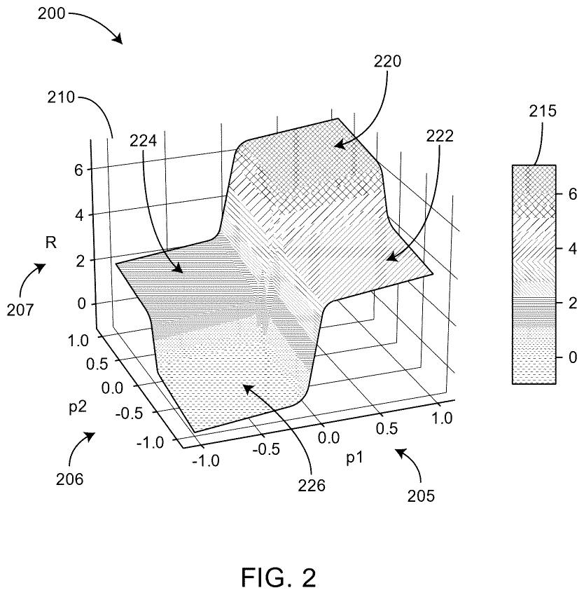

FIG. 2 is an illustration of a graph of an example reward for a two-rule hierarchy;

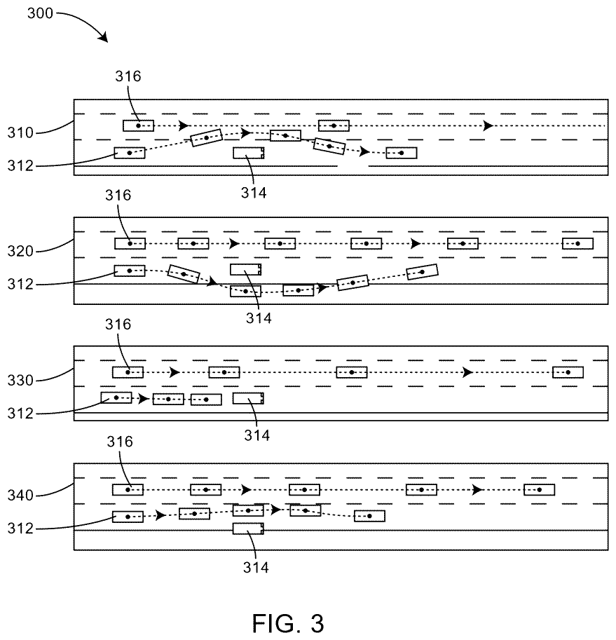

FIG. 3 is an illustration of a diagram of an example reward trajectory decision for an ego AV;

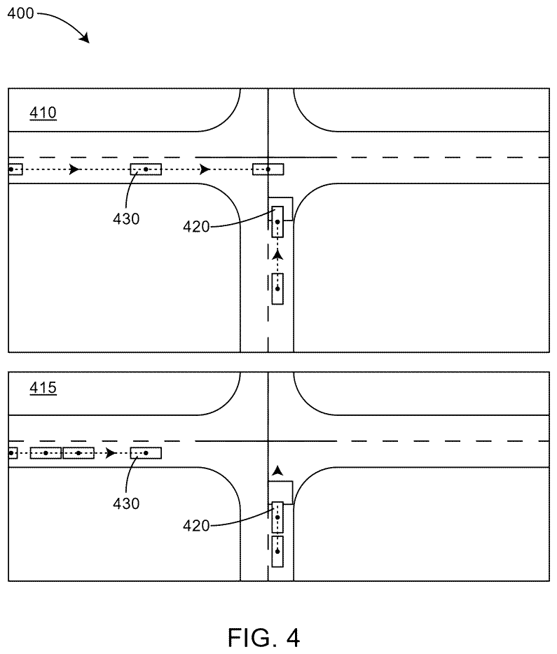

FIG. 4 is an illustration of a diagram of an example reward velocity decision for an ego AV;

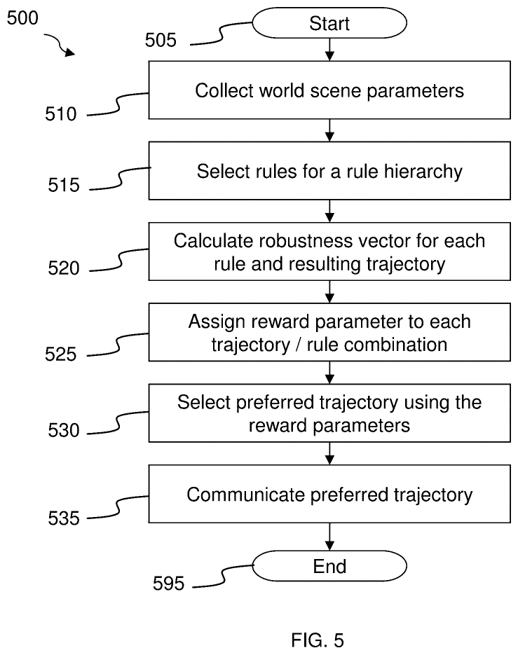

FIG. 5 is an illustration of a flow diagram of an example method for using a reward model for multiple rule hierarchies;

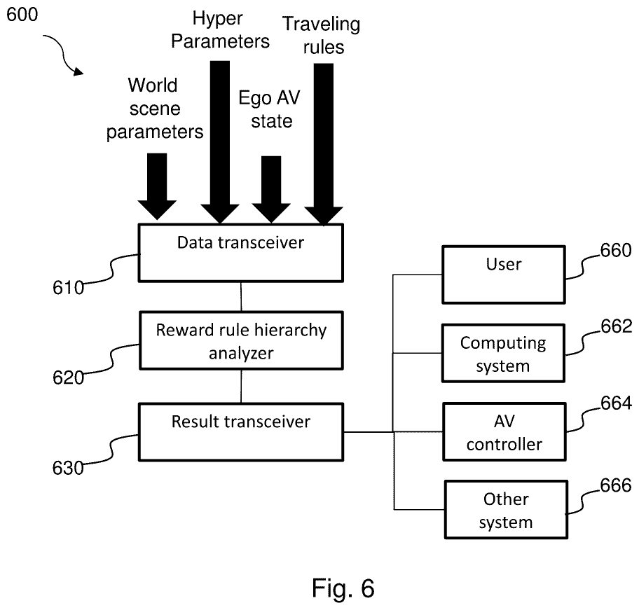

FIG. 6 is an illustration of a block diagram of an example reward rule hierarchy system; and

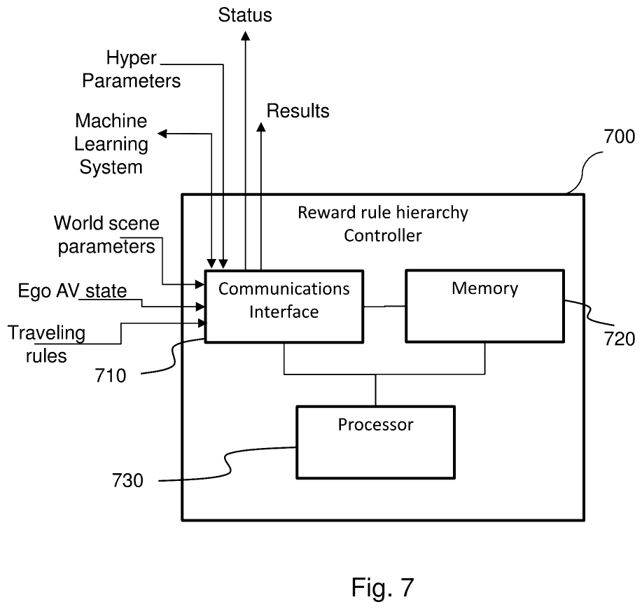

FIG. 7 is an illustration of a block diagram of an example of a reward rule hierarchy controller according to the principles of the disclosure.

### DETAILED DESCRIPTION

Autonomous Vehicles (AVs) must satisfy a plethora of rules pertaining to safety, traffic rules, passenger comfort, and progression towards the goal. These rules can conflict with each other when unexpected events occur. For example, avoiding a collision with a stationary or dangerously slow non-ego vehicle on the highway might necessitate swerving on to the shoulder, violating the traffic rule to keep the shoulder clear. To resolve the juxtaposing requirements posed by these rules, the rules can be ordered according to their importance, which results in the ranking of the trajectories derived from the rules. Trajectories that satisfy higher importance rules in the hierarchy are ranked higher than those trajectories which satisfy lower importance rules.

Rule hierarchies can provide a systematic approach to plan motions that prioritize more important rules (e.g., safety) over the less important ones (e.g., comfort) in the event that the set of rules cannot be simultaneously satisfied. Furthermore, they offer greater transparency in planner design and are more amenable to introspection. Rule hierarchies can introduce significant combinatorial complexity to planning in more complex scenarios. For example, at N number of rules in the hierarchy can result in 2^{N} optimization problems. Using a flat differentiable reward function, such as using weighted rules, can be less interpretable and be less diagnosable.

Rule hierarchies and flat weighted reward structures each have benefits and drawbacks in implementations for AV vehicles. The disclosed processes demonstrates that these two rule structures can be combined to take advantage of the expressive power of hierarchies and the optimization techniques available to weighted flat structures.

The disclosed processes for planning with rule hierarchies solves two optimization problems (as opposed to the potential worst-case 2^{N} optimization problems) regardless of the choice of N. A rank-preserving reward function R can be defined that exhibits the following property: higher ranked trajectories that satisfy more important rules receive a higher reward compared to trajectories that only satisfy lower importance rules. Maximizing this reward directly allows the process to select trajectories that have a higher rule-priority ordering, while not needing to check every combination of rules.

This reward function can be nonlinear and can result in more than one local maxima. To resolve this issue, the disclosed processes utilize a two-stage planning approach: the first stage can search through a finite set of primitive trajectories and selects the trajectory that satisfies the highest priority rules. The second stage warm starts a continuous optimization for maximizing the reward R with the trajectory supplied by the first-stage. There is no assumption of an a priori reference trajectory in this disclosure.

This disclosure particularly points out (1) a systematic approach to constructing a rank preserving reward function for any given rule hierarchy (see, for example, Equation 6 and Equation 7). (2) A two-stage receding-horizon planning approach that leverages the rank preserving reward to plan with rule hierarchies. In some aspects, this planning approach can result in an operational frequency of approximately 7.0 to 10.0 hertz (Hz). (3) The rank-preserving reward planner can adapt more quickly than existing solutions to challenging road navigation and intersection negotiation scenarios while not having scenario-specific hyperparameter tuning. These points show that the disclosed processes and algorithms can be performed in real-time, or near real-time on the ego AV, for example, having a total planning time of around 1/10^{th} of a second.

The ego AV will be used as example in this disclosure, while the features of the disclosure apply to other vehicles with a driver-assistance system, such as a semi-autonomous vehicles, a driver assisted vehicle, or a technology assisted vehicle. The features can be implemented in the control systems for each of the vehicles, such as a vehicle control system. The driver-assistance system can be an advanced driver assistance system (ADAS). The features of this disclosure can also be used in other systems, including computer vision systems, robotic systems, or other types of autonomous machines or devices.

In this disclosure, the AV for whose trajectory is being planned is known as the ego AV. There can be zero or more non-ego AVs within the world scene parameters of the ego AV. There can be zero or more non AVs within the world scene parameters of the ego AV, such as people, bicycles, trees, signs, buildings, bridges, and various other objects or obstructions. Equation 1 demonstrates discrete-time dynamic parameters for the ego AV.
Equation 1: Example discrete-time dynamic parameters for an ego AV
xₜ₊₁=f(xₜ, uₜ) where x ∈ X ⊆ [symbol] ⁿ is the ego AV's state,
u ∈ U ⊆ [symbol] ^{m} is the control actions,
n is the dimensional space of real numbers, for example, the state of the AV can be expressed by four real numbers: x-position, y-position, speed, and heading angle. The AV state (x-position, y-position, speed, heading) can be expressed as a single point in a 4-dimensional space of real numbers denoted by R⁴,
m is the dimensional space of real numbers, similar to the variable n.
t is the discrete-time,
x is the state of the AV, such as velocity, heading, acceleration, and other parameters,
u is the control action, e.g., steering, acceleration, braking, and other parameters,
X is the set of ego AV states for the ego AV,
U is the set of control actions available to the ego AV, and
where the relationship f: X×U→X is continuously differentiable.

Equation 2 is an example world scene equation that can be used as a set of world scene parameters.
Equation 2: Example world scene equation
w:=(X_{ne,0:T}, Xₘₐₚ) ∈ W where w is the set of world scene parameters that can be conveyed to the processor,
Xₙₑ is the state of a non-ego agents, such as non-ego AVs or other objects,
Xₘₐₚ is the world scene parameters, such as lane lines, stop signs, and other word scene parameters,
X_{ne,0:T} is non-ego agent state trajectories over the determined time-steps T, and
W is a set of world scene parameters.

For the disclosed algorithms, S is the set of trajectories generated from an initial state x₀ ∈ X and evolving under the influence of a control sequence u_{0:T} spanning a horizon of T time-steps. A rule ϕ:S×W→{True, False} is defined as a Boolean function that maps an ego AV trajectory x_{0:T} ∈ S and the world scene w ∈ W to True or False, depending on whether the trajectory satisfies the rule. The robustness \hat{p}ᵢ: S×W→ [symbol] R of a rule ϕᵢ is a metric that can provide the degree of satisfaction for a rule. The robustness is a positive scalar if the rule is satisfied and negative otherwise. More positive values indicate greater satisfaction of the rule while more negative values indicate greater violation.

A rule hierarchy φ can be defined as a sequence of rules φ:={ϕᵢ}ᵢ₌₁^{N} where the highest priority rule is indexed by 1 and the lowest priority rule by N. The rules can be selected from a set of traveling rules assigned to the ego AV. The robustness of a rule hierarchy φ for a trajectory x_{0:T} ∈ S in a world scene w ∈ W can be an N-dimensional vector-valued function whose elements comprise the robustness of the N-rules in φ, and be expressed for example as \hat{p}:(x_{0:T}, w)→\hat{p}₁(x_{0:T}, w), . . . , \hat{p}_{N}(x_{0:T}, w)).

The rule hierarchy can be used to derive an order of trajectories. For example, if a trajectory satisfies the set of rules, then it can have the highest rank in the order. If the trajectory satisfies the set of rules except for the lowest priority rule, then it can have the second rank. A similar pattern can be followed for the remaining combinations of priority rules satisfied. Table 1 provides an example ordered hierarchy for a 3 rule combination, where Φ₁ is the highest priority rule, Φ₂ is a medium priority rule, and Φ₃ is the lowest priority rule.

TABLE 1
Example 3 rule combination of satisfied hierarchy rules

| Ordered | Satisfied |
|---|---|
| Rank | Rules |
| 1 | Φ₁, Φ₂, Φ₃ |
| 2 | Φ₁, Φ₂ |
| 3 | Φ₁, Φ₃ |
| 4 | Φ₁ |
| 5 | Φ₂, Φ₃ |
| 6 | Φ₂ |
| 7 | Φ₃ |
| 8 | Ø |

A robustness vector for a trajectory can be described as ρ:=\hat{p}(x_{0:T}, w). Using the robustness vector, the rank of the trajectory can be defined as shown in Equation 3. When given φ has a rule hierarchy with N rules, a trajectory xo:T and world scene parameters w, the robustness vector of the trajectory can be defined as ρ:=(ρ₁, ρ₂, . . . ρ_{N}). The step function can be defined as step:= [symbol] →{0,1}, where negative real numbers can be mapped to 0, and other real numbers to 1. The rank r: [symbol] ^{N}→{1,2, . . . , 2^{N}} can be determined using Equation 3.

$$Equation 3 : Example calculation or a rank of a trajectory$$

$$r ( ρ ) := {2}^{N} - {\sum }_{i = 1}^{N} {2}^{N - i} step ( {ρ}_{i} )$$

This disclosure describes that an optimization to obtain control actions that result in a trajectory with the highest achievable rank according to the provided rule hierarchy. For example, Equation 4 demonstrates an optimization process to select the control actions, such as selecting motion primitives, to minimize the rank r of the trajectory. This can be evaluated while not needing to check 2^{N}combinations for rule satisfaction. In some aspects, control bounds can be included within the rule hierarchy φ.

$$Equation 4 : Example optimization to select the minimum control actions$$

$$\begin{matrix}min \\ {u}_{0 : T}\end{matrix} r ∘ \hat{p} ( {x}_{0 : T} , w )$$

where xₓ₊₁=f(xₜ, uₜ), for each time-step t in {1, 2, . . . , T}.

To avoid evaluating the various combinations for rule satisfaction, a differentiable rank - preserving reward function can be utilized. As a first step, a rank-preserving reward function can be demonstrated that assigns rewards for trajectories with higher rank and lower rewards for trajectories with lower rank. Equation 5 is an example rank-preserving relationship. This equation does not impose a restriction should two trajectories have the same rank. Other factors can be used to determine a tie-breaker, or can be specified by the design of the system.
Equation 5: Example rank-preserving relationship
R:ρ→R(ρ) ∈ [symbol] R which satisfies r(ρ)<r(\acute{ρ})⇒R(ρ)>R(\acute{ρ}) where R is the reward, and
\acute{ρ} is another robustness vector in the set of robustness vectors.

Equation 5 relationship can then be used to define a rank-preserving reward computation, such as shown in Equation 6. Equation 6 helps to ensure that the reward contribution on satisfaction of a rule I, should exceed the sum of the reward contributions by rules with lower priority. This can be implemented by multiplying the step function with a number that grows exponentially in relation to the priority of the rule. To assist in distinguishing between trajectories that have the same rank, the average robustness for the set of N rules can be used as criterion.

$$Equation 6 : Example rank - preserving reward equation R$$

$$R ( ρ ) := {\sum }_{i = 1}^{N} ( {a}^{N - i + 1} step ( {ρ}_{i} ) + \frac{{ρ}_{i}}{N} ) .$$

where

$$\frac{{ρ}_{i}}{N}$$

is ure sum of ule average robustness across the rules in the rule hierarchy,
a is greater than 2, and
ρᵢ is an element of [−a/2, a/2] for any i that is an element of {1, 2, . . . , N}.

In some aspects, the reward determined using Equation 6 may not be differentiable since it utilizes a step function. To facilitate continuous optimization using the reward equation, the step function can be modified by applying sigmoid functions. Equation 7 is an example sigmoid applied to the reward equation.

$$Equation 7 : Example rank - preserving reward equation R$$

$$R ( ρ ) := {\sum }_{i = 1}^{N} ( {a}^{N - i + 1} sigmoid ( c {ρ}_{i} ) + \frac{{ρ}_{i}}{N} ) .$$

where c is greater than zero and is a scaling constant chosen to mimic the step function.

These reward calculations can be completed in sufficient time to enable real world navigation decisions to be made. Since two optimizations per planning cycle are utilized rather than 2^{N} combinations, the reward cycle can be completed, for example, in 7 to 10 iterations per second. The planning cycles have shown to have low deviations in experimental applications further enhancing the benefits of this disclosed approach. The use of consistent hyperparameters (such as robustness scaling, sigmoid constant, and other parameters not associated with the world scene parameters, the ego AV motion primitives, or the ego AV control parameters) can be beneficial to the benefits achieved by this disclosure.

Turning now to the figures, FIG. 1 is an illustration of a diagram of an example trajectory decision 100 moment for an ego AV. Trajectory decision 100 can represent a typical scenario experienced on a two lane or multi-lane roadways. Trajectory decision 100 demonstrates a simple case where multiple decision rules can come into play, where one rule needs to be selected for the AV to proceed most safely. Trajectory decision 100 has a roadway 110 with two lanes traveling in the same direction, separated by dashed lines 115. Roadway 110 has a shoulder 117.

Driving on roadway 110 is an ego AV 120, this being the AV for which the trajectory decision is needed. A non-ego AV 130 is traveling (as shown by the trajectory arrow in the front of non-ego AV 130) nearby on roadway 110 in a different lane from ego AV 120. A non-ego AV 140 is shown in a distressed state, which can be traveling in the same direction as ego AV 120 while at significantly slower than velocity than ego AV 120, or non-ego AV 140 can be stopped.

Trajectory decision 100 is showing a simple two-rule hierarchy, where one rule is ‘no collision’ and a second rule is ‘avoid shoulder’. A trajectory 150 would likely lead to a collision event with non-ego AV 130. A trajectory 152 would likely lead to a collision event with non-ego AV 140. A trajectory 154 would likely be the safest selection as the ‘no collision’ rule would be ranked higher than the ‘avoid shoulder’ rule. Trajectory 154 is shown as a solid line indicating that it will receive a higher rank than the other trajectories when the disclosed processes are applied.

FIG. 2 is an illustration of a graph of an example reward 200 for a two-rule hierarchy. Reward 200 demonstrates the increasing complexity as additional rules are added to the analysis of determining the least objectionable trajectory of the ego AV. Reward 200 has a three-dimensional (3D) graph area 210 to plot the reward functions for the two rules. 3D graph area 210 has an x-axis p1 205 indicating the robustness vector of a first trajectory derived from a first rule. 3D graph area 210 has a y-axis ρ2 206 indicating the robustness vector of a second trajectory derived from a second rule. 3D graph area 210 has a z-axis R 207 indicating the reward result from the robustness of the two rules being considered. Key 215 indicates the relative reward value for each portion of the plotted data.

Plotted in 3D graph area 210 are the resulting reward values for various combinations of robustness vectors derived from the trajectories resulting from an application of the two rules in the hierarchy. An area 220 indicates that the two rules result in similar rewards, at a 5.0 to 7.0 range. In this scenario, other factors can be utilized to select one resulting trajectory over the other trajectory. An area 222 indicates that if the robustness vector for the trajectory derived from the first rule is positive and the robustness vector for the trajectory derived from the second rule is zero or negative, then the reward results in a range of 2.0 to 4.0. An area 224 indicates that if the robustness vector for the trajectory derived from the second rule is positive and the robustness vector for the trajectory derived from the first rule is zero or negative, then the reward results in a range of around 2.0. An area 226 indicates that if the robustness vector for the trajectory derived from the first rule is negative and the robustness vector for the trajectory derived from the second rule is negative, then the reward results in a range around zero. This demonstrates that the satisfaction of rule 1 (area 222) is ranked higher than satisfying rule 2 (area 224), and the resulting reward assignment to the trajectory derived from rule 1 should have a correspondingly higher reward parameter.

Area 220, area 222, area 224, and area 226 demonstrate a visual comparison of the relative rewards where the rule that produces the highest reward can be selected, and how a combination of rules can enhance the selection of a rule. For example, the combination of rule 1 and rule 2 with higher robustness vectors result in a higher resulting reward than either rule on its own.

FIG. 3 is an illustration of a diagram of an example reward trajectory decision 300 for an ego AV. Reward trajectory decision 300 demonstrates four potential trajectories for an ego AV 312. The rules in the hierarchy are (1) no collision with another vehicle, (2) no crossing a solid line, (3) no crossing a dashed line, (4) avoid the shoulder, (5) orient along the current lane by the end of the planning horizon, (6) maintain a minimum speed of travel (for example, 2 meters per second (m/s)), and (7) avoid excessive speeding (for example, 15 m/s). In each of the potential trajectories, a non-ego AV 314 is stopped or traveling very slowly on the roadway. The various AVs are traveling in a direction as indicated by the arrows associated with each AV.

Trajectory 310 shows that ego AV 312 can move into a parallel lane, crossing a dashed line, while avoiding a non-ego AV 316 and can return the selected travel lane. Trajectory 320 shows that ego AV 312 can move onto the shoulder, crossing a solid line, and can return the selected travel lane. Trajectory 330 shows that ego AV 312 can come to stop, violating the minimum travel speed rule. Trajectory 340 shows that ego AV 312 can pass non-ego AV 314 and stay within the selected travel lane since non-ego AV 314 is pulled over far enough onto the shoulder of the roadway. In each of these trajectories, one or more rules would need to be violated in order for ego AV 312 to continue traveling. The disclosed processes can result in a selection of a least objectionable action.

FIG. 4 is an illustration of a diagram of an example reward velocity decision 400 for an ego AV. FIG. 3 demonstrated an application of the disclosed processes for traveling on a roadway where the AVs are traveling in the same or similar directions. Reward velocity decision 400 demonstrates where AVs are traveling in different directions. The various AVs are traveling in a direction as indicated by the arrows associated with each AV.

In a trajectory 410, an ego AV 420 has determined that stopping at the intersection results in a least objectionable result. Non-ego AV 430 has been given the right of way to cross the intersection of the roadway. For example, violating a minimum speed rule is better than violating a collision rule.

In a trajectory 415, ego AV 420 has determined that proceeding through the intersection results in a least objectionable result. Non-ego AV 430 is far enough away or is traveling at a sufficiently slow speed that ego AV 420 can safely cross the intersection of the roadway. For example, maintaining a minimum speed rule does not end up violating other rules.

FIGS. 1-4 demonstrate visual graphs or diagrams for AV trajectory decisions. In some aspects, a visual component is not used and the implementation can analyze the collected AV data as data within a computing system, such as using a database or other data store. A graph or visual component is not needed.

FIG. 5 is an illustration of a flow diagram of an example method for using a reward model for multiple rule hierarchies. Method 500 can be performed on a computing system, for example, reward rule hierarchy system 600 of FIG. 6 or reward rule hierarchy controller 700 of FIG. 7. The computing system can be an AV controller, one or more processors, a data center, a cloud environment, a server, a laptop, a mobile device, a smartphone, a PDA, or other computing system capable of receiving the AV data, input parameters, and capable of communicating with other computing systems. Method 500 can be encapsulated in software code or in hardware, for example, an application, code library, dynamic link library, module, function, RAM, ROM, and other software and hardware implementations. The software can be stored in a file, database, or other computing system storage mechanism. Method 500 can be partially implemented in software and partially in hardware. Method 500 can perform the steps for the described processes, for example, determining a reward ranking of a rules hierarchy and selecting the preferred rule.

The algorithm can be separated into two stages, where stage one is a planning stage with motion primitives. A coarse initial trajectory for warm starting the continuous optimizer can be generated. The initial trajectory can be selected as the trajectory with the largest rule hierarchy reward R from a finite set of motion primitives. The motion primitives can be determined from a set of M open-loop controls that cover a variety of control actions that the ego AV can perform. Using the open-loop controls, the ego AV can be projected forward in time from the initial state over a series of time-steps, e.g., a propagation of the ego AV using the motion primitives over a determined number of time-steps. This can generate |M| branches of trajectory possibilities, where |M| is the cardinality of M. At each node of the |M| branches, the control actions can be applied again for the subsequent time-step. Repeating this process over the full time interval T can generate a tree with

$${\vert M \vert}^{⌈ \frac{T}{set of motion primitives} ⌉} .$$

In some aspects, this tree can be generated by parallelizing the calculations for each branch, thereby improving the generation efficiency.

The second stage can focus on the continuous trajectory optimization, such as resolving the equation shown in Equation 4. Owing to the lack of convexity of this optimization problem. there is no assurance of reaching a global optimal solution. Convergence to a local optima in the vicinity of the initial parameters can improve the trajectory's compliance to the rule hierarchy.

Method 500 starts at a step 505 and proceeds to a step 510. In step 510 world scene parameters can be collected as a set. The world scene parameters can include, for example, other AVs near the ego AV, other moving objects (such as humans, animals, bicycles, balls, or other moving objects), or other non-moving objects (such as signs, trees, parked vehicles, stanchions, guardrails, or other non-moving objects). Collectively, the word scene parameters represent the 3D world around the ego AV for which the ego AV needs to be concerned with as the ego AV makes trajectory decisions on how to proceed with its intended motion.

In a step 515, a set of rules can be collected to form a rule hierarchy. The set of rules can be derived from a set of traveling rules available to the ego AV. The set of rules can vary depending on the location of the ego AV. For example, if the ego AV is on a highway, an applicable rule may be to maintain a minimum speed of 17.5 m/s, while on school property, the maximum speed rule can be set at 6.5 m/s.

In a step 520, the robustness vector for each rule in the rule hierarchy can be calculated using the resulting trajectory determined using that rule. In some aspects, the robustness vector calculation can utilize a series of trajectory locations calculated over a series of time-steps. Motion primitives can be applied at each time-step to the ego AV to determine the future potential position of the ego AV if the trajectory is followed, e.g., propagating the ego AV at each time-step. A determination can be made if that selected trajectory continues to satisfy the high priority rules in the rule hierarchy (such as non-collision). If the projected trajectory violates some rules, the robustness can be modified to lower the robustness therefore lowering its potential to be selected.

In a step 525, a reward parameter can be assigned to each trajectory / rule combination. The reward can be in proportion to the robustness vector, whereby the trajectories that satisfy the greatest number of higher priority rules will result in having the highest reward, see, for example, Equations 6 and 7. This will result in a set of reward parameters associated with the proposed trajectories for the ego AV. In some aspects, a stochastic optimization can be applied to the reward parameter over a determined set of time-steps, where a motion primitive can be applied to the ego AV at each time-step. In some aspects, the robustness vectors can be modified prior to assigning the reward parameter by applying an average robustness to the reward parameter calculation. The average robustness modification can assist in differentiating trajectories that have the same rank.

In a step 530, a preferred trajectory can be selected using the reward parameters assigned in step 525. The preferred trajectory represents the highest reward trajectory as determined by the rank-preserving reward computations. If there are ties in the reward ranking, other factors can be utilized to select the preferred trajectory or the determination can be made by the system design.

In a step 535, the preferred trajectory can be communicated to an AV controller which can select the appropriate motion primitive (i.e., control action) to implement the preferred trajectory for the ego AV, whether it is an action or an inaction. As such the AV controller can direct the operation of the ego AV utilizing the preferred trajectory and the selected motion primitives. Method 500 ends at a step 595.

In some aspects, methods of this disclosure can also be represented by pseudocode. The example pseudocode presented in Pseudocode 1 utilizes a different representation of the steps and with some steps in different orders then as described for method 500. Pseudocode 1 demonstrates one potential implementation of the various steps described for the disclosed processes.

Pseudocode 1: Example implementation of the disclosed algorithms

1: Input: Reward function R for the rule hierarchy φ
2: Hyperparameters: Total planning time T̅, planning horizon T, number of time-steps to
execute t_{execute}
3: Hyperparameters for Planning with Primitives: set of open-controls for motion
primitive tree generation M, number of steps t for which a control action in M is executed
4: Hyperparameters for Continuous Optimizer: learning rate lr, maximum iterations K
5: while t < T̅ do
6: Xₜ ← updateEgoState ( )
7: w ← updateWorldScene ( )
8: PrimitiveTree ← generatePrimitiveTree (xₜ, M, t, T)
9: u_{t:t+T} ← argumentMax_{PrimitiveTree} R
10: for k in 1 : K do
11: compute -∇u_{t:t+T}R
12: U_{t:t+T} ← optimizer (u_{t:t+T}, -∇u_{t:t+T}R, lr)
13: end for
14: Execute (u_{t:t+texecute})
15: t ← t + t_{execute}
16: end while

FIG. 6 is an illustration of a block diagram of an example reward rule hierarchy system 600, which can be implemented in one or more computing systems or one or more processors, for example, a vehicle control system, an AV processor, an AV controller, a graphics processing unit, a data center, cloud environment, server, laptop, smartphone, tablet, and other computing systems. In some aspects, reward rule hierarchy system 600 can be implemented using a reward rule hierarchy controller such as reward rule hierarchy controller 700 of FIG. 7. Reward rule hierarchy system 600 can implement one or more methods of this disclosure, such as method 500 of FIG. 5.

Reward rule hierarchy system 600, or a portion thereof, can be implemented as an application, a code library, a dynamic link library, a function, a module, other software implementation, or combinations thereof. In some aspects, reward rule hierarchy system 600 can be implemented in hardware, such as a ROM, a graphics processing unit, or other hardware implementation. In some aspects, reward rule hierarchy system 600 can be implemented partially as a software application and partially as a hardware implementation. Reward rule hierarchy system 600 is a functional view of the disclosed processes and an implementation can combine or separate the described functions in one or more software or hardware systems.

Reward rule hierarchy system 600 includes a data transceiver 610, a reward rule hierarchy analyzer 620, and a result transceiver 630. The results, e.g., the selected preferred trajectory, analysis, and interim outputs from reward rule hierarchy analyzer 620 can be communicated to a data receiver, such as one or more of a user or user system 660, a computing system 662, an AV controller 664, or other processing or storage systems 666. The results can be used to determine the motion primitives provided to the ego AV to determine what control action is implemented over the next time action step.

Data transceiver 610 can receive various input parameters. The input parameters can include world scene parameters which describe moving objects, non-moving objects, weather conditions, and rules of the road in an area of interest to the ego AV. The input parameters can include hyperparameters, or general parameters for the implementation of he disclosed processes. The hyperparameters can include constants used for the sigmoid function, scalars, and other general parameters used in the disclosure. The input parameters can include the state of the ego AV, such as the direction, speed/velocity, location, how quickly the ego AV can stop, and other parameters of the ego AV. The input parameters can include the traveling rules available to the ego AV. In some aspects, data transceiver 610 can be part of reward rule hierarchy analyzer 620.

In some aspects, the input parameters can be received from one or more sensors located on the ego AV. For example, the set of world scene parameters can be received from one or more cameras, one or more radar systems, one or more lidar systems, or a combination of these, located around the ego AV. In some aspects, the set of world scene parameters can be received from an input receiver on the ego AV. For example, the input receiver can receive the input parameters from a transmitter not part of the ego AV, such as a source located on a nearby traffic light, a satellite, a communications tower, a non-ego AV, or other transmitter not part of the ego AV.

Result transceiver 630 can communicate one or more results, analysis, or interim outputs, to one or more data receivers, such as user or user system 660, computing system 662, AV controller 664, or other processing or storage systems 666, e.g., a data store or database, or other related systems, whether located proximate result transceiver 630 or distant from result transceiver 630. Data transceiver 610, reward rule hierarchy analyzer 620, and result transceiver 630 can be, or can include, conventional interfaces configured for transmitting and receiving data. In some aspects, reward rule hierarchy analyzer 620 can be a machine learning system, such as to apply learned trajectory models to the selected rule hierarchy.

Reward rule hierarchy analyzer 620 (e.g., one or more processors such as processor 730 of FIG. 7) can implement the analysis and algorithms as described herein utilizing the various input parameters. For example, reward rule hierarchy analyzer 620 can select a set of rules for a rule hierarchy from the traveling rules, determine a trajectory derived from each rule in the hierarchy, determine a robustness vector for each trajectory, and determine a rank-preserving reward for each trajectory using the robustness vector. A preferred trajectory can be determined from the set of rank-preserving rewards.

A memory or data storage of reward rule hierarchy analyzer 620 can be configured to store the processes and algorithms for directing the operation of reward rule hierarchy analyzer 620. Reward rule hierarchy analyzer 620 can also include a processor that is configured to operate according to the analysis operations and algorithms disclosed herein, and an interface to communicate (transmit and receive) data.

FIG. 7 is an illustration of a block diagram of an example of a reward rule hierarchy controller 700 according to the principles of the disclosure. Reward rule hierarchy controller 700 can be stored on a single computer or on multiple computers. The various components of reward rule hierarchy controller 700 can communicate via wireless or wired conventional connections. A portion or a whole of reward rule hierarchy controller 700 can be located at one or more locations and other portions of reward rule hierarchy controller 700 can be located on a computing device or devices located on or away from the ego AV. In some aspects, reward rule hierarchy controller 700 can be part of another system, and can be integrated in a single device, such as a part of an AV controller, an AV processor, an AV system, a vehicle control system, a robotic control system, or other system using artificial intelligence to direct a movement of a movable object, e.g., another type of autonomous machine or robotic device.

Reward rule hierarchy controller 700 can be configured to perform the various functions disclosed herein including receiving input parameters and generating results from an execution of the methods and processes described herein, such as determining a preferred trajectory, and other results and analysis. Reward rule hierarchy controller 700 includes a communications interface 710, a memory 720, and a processor 730.

Communications interface 710 is configured to transmit and receive data. For example, communications interface 710 can receive the input parameters. Communications interface 710 can transmit the results or interim outputs. In some aspects, communications interface 710 can transmit a status, such as a success or failure indicator of reward rule hierarchy controller 700 regarding receiving the various inputs, transmitting the generated results, or producing the results.

In some aspects, the input parameters can be received from one or more sensors located on the ego AV. For example, the set of world scene parameters can be received from one or more cameras, one or more radar systems, one or more lidar systems, or a combination of these, located around the ego AV. In some aspects, the set of world scene parameters can be received from an input receiver on the ego AV. For example, the input receiver can receive the input parameters from a transmitter not part of the ego AV, such as a source located on a nearby traffic light, a satellite, a communications tower, a non-ego AV, or other transmitter not part of the ego AV.

In some aspects, communications interface 710 can receive input parameters from a machine learning system, for example, where the rule hierarchy is processed using one or more optimizations and the machine learning system uses prior learned trajectory models to improve the determination of the robustness vectors.

In some aspects, the machine learning system can be implemented by processor 730 and perform the operations as described by reward rule hierarchy analyzer 620. Communications interface 710 can communicate via communication systems used in the industry. For example, wireless or wired protocols can be used. Communication interface 710 is capable of performing the operations as described for data transceiver 610 and result transceiver 630 of FIG. 6.

Memory 720 can be configured to store a series of operating instructions that direct the operation of processor 730 when initiated, including the code representing the algorithms for determining the preferred trajectory. Memory 720 is a non-transitory computer readable medium. Multiple types of memory can be used for data storage and memory 720 can be distributed.

Processor 730 can be one or more processors. Processor 730 can be a combination of processor types, such as a central processing unit, a graphics processing unit, or other processing types. Processor 730 can be configured to produce the results (e.g., determining the preferred trajectory, and other results), one or more interim outputs, and statuses utilizing the received inputs. Processor 730 can calculate the robustness vector for each trajectory using parallel processing. Processor 730 can be an integrated circuit. In some aspects, processor 730, communications 710, memory 720, or various combinations thereof, can be an integrated circuit. Processor 730 can be configured to direct the operation of reward rule hierarchy controller 700. Processor 730 includes the logic to communicate with communications interface 710 and memory 720, and perform the functions described herein. Processor 730 is capable of performing or directing the operations as described by reward rule hierarchy analyzer 620 of FIG. 6.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with the digital data processors or computers.

The digital data processors or computers can be comprised of one or more GPUs, one or more CPUs, one or more of other processor types, or a combination thereof. The digital data processors and computers can be located proximate each other, proximate a user, in a cloud environment, a data center, or located in a combination thereof. For example, some components can be located proximate the user and some components can be located in a cloud environment or data center.

The GPUs can be embodied on a single semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on a single chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
collecting a set of world scene parameters from an ego autonomous vehicle (AV);
selecting a rule hierarchy from a set of traveling rules for the ego AV;
calculating a robustness vector for one or more rules in the rule hierarchy utilizing a trajectory derived from the respective one or more rules, wherein the trajectory is derived using the set of world scene parameters;
assigning a reward parameter to the one or more rules in proportion to the respective robustness vector calculated for the one or more rules;
generating a set of reward parameters from the one or more rules and the associated reward parameters; and
selecting a preferred trajectory derived from the rule hierarchy using the set of reward parameters, wherein the preferred trajectory evaluates to a highest reward.

2. The method as recited in claim 1, further comprising:
communicating the preferred trajectory to an AV controller to select an appropriate motion primitive for the ego AV.

3. The method as recited in claim 1, wherein the calculating the robustness vector further comprises:
selecting a set of motion primitives that the ego AV can utilize;
computing a set of trajectory locations for the ego AV over a determined number of time-steps by simulating a propagation of the ego AV using the set of motion primitives; and
modifying the robustness vector using an evaluation of the one or more rules at one or more trajectory locations in the set of trajectory locations.

4. The method as recited in claim 3, wherein the computing the set of trajectory locations and the modifying the robustness vector is performed in parallel for the one or more rules.

5. The method as recited in claim 3, wherein the set of world scene parameters are updated at one or more time-steps in the number of time-steps.

6. The method as recited in claim 1, wherein a sigmoid function is applied to a step function for calculating the set of reward parameters.

7. The method as recited in claim 1, wherein the assigning the reward parameter further comprises:
applying a stochastic optimization to the reward parameter over a determined set of time-steps, wherein a motion primitive is applied to the ego AV at one or more time- steps in the set of time-steps.

8. The method as recited in claim 1, wherein the assigning the reward parameter further comprises:
modifying the respective robustness vector by applying an average robustness.

9. A system, comprising:
a receiver, operational to receive a set of world scene parameters, a set of hyperparameters, a set of ego autonomous vehicle (AV) states for an ego AV, and a set of traveling rules for the ego AV, wherein the ego AV is intending to move; and
one or more processors, operational to calculate a robustness vector for one or more trajectories derived from one or more rules in a rule hierarchy and select a preferred trajectory from the one or more trajectories using a reward parameter derived from the robustness vector, where the rule hierarchy is selected from the set of traveling rules and a calculation for the robustness vector utilizes the set of world scene parameters, the set of hyperparameters, and the set of ego AV states.

10. The system as recited in claim 9, further comprising:
a transceiver, operational to communicate the preferred trajectory to an AV processor, an AV controller, or a storage system.

11. The system as recited in claim 9, where the one or more processors are a reward rule hierarchy analyzer.

12. The system as recited in claim 9, where the one or more processors are one or more of a central processing unit or one or more of a graphics processing unit.

13. The system as recited in claim 9, wherein the one or more processors calculates the robustness vector for the one or more trajectories using parallel processing.

14. The system as recited in claim 9, wherein the one or more processors is further operational to project the ego AV at a location corresponding to a time in a series of time- steps, where the ego AV utilizes one or more motion primitives to reach the location.

15. The system as recited in claim 9, wherein the one or more processors is further operational to utilize one or more optimizers when deriving the reward parameter from the robustness vector.

16. The system as recited in claim 9, wherein the one or more processors is further operational to utilize a machine learning system utilizing a trajectory model and the rule hierarchy.

17. The system as recited in claim 9, further comprising:
a driver assisted vehicle including a vehicle control system that directs an operation of the driver assisted vehicle, wherein the one or more processors provide input to the vehicle control system.

18. The system as recited in claim 9. wherein the receiver and the one or more processors are part of an integrated circuit.

19. A computer program product having a series of operating instructions stored on a non- transitory computer-readable medium that directs a data processing apparatus when executed thereby to perform operations to determine a preferred trajectory for an ego autonomous vehicle (AV), the operations comprising:
collecting a set of world scene parameters from the ego AV;
selecting a rule hierarchy from a set of traveling rules for the ego AV;
calculating a robustness vector for one or more rules in the rule hierarchy utilizing a trajectory derived from a respective one or more rules, wherein the trajectory is derived using the set of world scene parameters;
assigning a reward parameter to the one or more rules in proportion to the respective robustness vector calculated for the one or more rules;
generating a set of reward parameters from the one or more rules and the associated reward parameters; and
selecting the preferred trajectory derived from the rule hierarchy using the set of reward parameters, wherein the preferred trajectory evaluates to a highest reward.

20. A computing system, comprising:
a receiver, operational to receive a set of world scene parameters, a set of hyperparameters, a set of states for a robotic device, and a set of traveling rules for the robotic device, wherein the robotic device is intending to move; and
one or more processors, operational to calculate a robustness vector for one or more trajectories derived from one or more rules in a rule hierarchy and select a preferred trajectory from the one or more trajectories using a reward parameter derived from the robustness vector, where the rule hierarchy is selected from the set of traveling rules and a calculation of the robustness vector utilizes the set of world scene parameters, the set of hyperparameters, and the set of states.
